(19) United States
(12) Patent Application Publication
(10) Pub. No.: US 2016/0300283 A1
(43) Pub. Date: Oct. 13, 2016

(54) METHOD AND SYSTEM FOR FACILITATING DONATIONS

(71) Applicant: Change Up Inc., Wilmington, DE (US)

(72) Inventor: Robert W. Soderstrom, Los Angeles, CA (US)

(21) Appl. No.: 15/181,781

(22) Filed: Jun. 14, 2016

Related U.S. Application Data
(63) Continuation-in-part of application No. 14/625,612, filed on Feb. 18, 2015.
Application No. 14/625,612 is a continuation-in-part of application No. 13/738,949, filed on Jan. 10, 2013, now abandoned.
(60) Provisional application No. 61/610,912, filed on Mar. 14, 2012.
(60) Provisional application No. 61/585,075, filed on Jan. 10, 2012.

(51) Int. Cl. G06Q 30/06; G06Q 50/00

(52) U.S. Cl. CPC G06Q 30/0613; G06Q 50/01

(57) ABSTRACT

A computer-implemented method for enabling an individual to round up the monetary cost of a purchase to a specified amount and contribute the difference to a third party. More specifically, the method allows a user to round up a purchase to the nearest dollar or other amount and then contribute that change to a pool of donations, and further allows fundraising campaigns to compete for the pool of donations through various competitive, social media-based games. In some embodiments, the present invention may be incorporated directly within a digital wallet on a mobile device. In other embodiments the present invention may be a stand-alone application on a mobile device that interfaces with a digital wallet.

### CROSS REFERENCE TO RELATED APPLICATIONS

This application is a continuation-in-part of application Ser. No. 14/625,612, filed Feb. 18, 2015, titled GAMING SYSTEM FOR FACILITATING COMPETITION BETWEEN FUNDRAISING CAMPAIGNS, which is a continuation-in-part of application Ser. No. 13/738,949, filed Jan. 10, 2013, titled MOBILE APPLICATION FACILITATING MONETARY OR OTHER DONATIONS, which claims the benefit of U.S. Provisional Application Ser. No. 61/585,075, filed Jan. 10, 2012, titled MOBILE APPLICATION FACILITATING MONETARY OR OTHER DONATIONS and U.S. Provisional Application Ser. No. 61/610,912, titled MOBILE APPLICATION FACILITATING MONETARY OR OTHER DONATIONS, filed Mar. 14, 2012.

### SUMMARY OF THE INVENTION

The present invention relates to an application on a mobile phone, portable digital device, or personal computer that creates a game between fundraising campaigns, wherein user-generated donations that are based off of a digital wallet that rounds up purchases to the nearest dollar or other amount are added to a donation pool that the fundraising campaigns are competing against each other to win.

For example, if a user uses their digital wallet to make a purchase of $7.72, the present invention would allow the user to round-up 28 cents to the nearest dollar ($8.00). The 28 cents is then held, and the user can donate the 28 cents to a donation pool for a general category that contains a plurality of fundraising campaigns, each competing to win the donation pool using social media.

Reference is made throughout the present disclosure to certain aspects of one embodiment of the application described herein. Such references to aspects of the presently described application do not limit the scope of the claimed invention. Additionally, any examples set forth in this disclosure are not intended to be limiting and merely set forth some of the many possible embodiments for the appended claims. It is to be understood that the phraseology and terminology used herein are for the purpose of description and should not be regarded as limiting.

### BRIEF DESCRIPTION OF THE DRAWINGS

FIG. 1 is an example graphical user interface according to one embodiment of the mobile application.

FIG. 2 is an example graphical user interface according to one embodiment of the mobile application.

FIG. 3 is an example graphical user interface according to one embodiment of the mobile application.

FIG. 4 is a schematic block diagram of an example computing system.

### DETAILED DESCRIPTION

Various user interfaces and embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims. It is understood that various omissions and substitutions of equivalents are contemplated as circumstances may suggest or render expedient, but these are intended to cover applications or embodiments without departing from the spirit or scope of the claims attached hereto. Also, it is to be understood that the phraseology and terminology used herein are for the purpose of description and should not be regarded as limiting.

### Mechanics and Larger Ecosystem

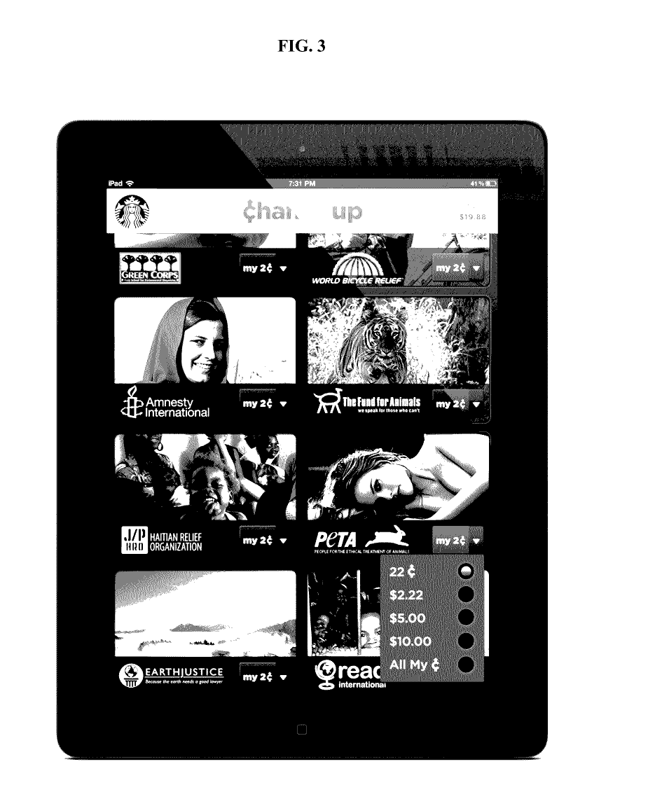

In some embodiments, the present invention may be incorporated directly into a digital wallet on a mobile device. In other embodiments the present invention may be a stand-alone application on a mobile device that interfaces with a digital wallet, as illustrated in FIG. 3. The system facilitates aggregation of personal donations between individuals, organizations, fundraising campaigns, and physical locations. The system further permits various means of communication, including social media communication and notification, related to donation and aggregation activity.

In a preferred embodiment of the present invention, the user, in a retail store environment or an online purchase environment, is charged for only the rounded up amount (28 cents, in the example above) as if it were a purchase. The round-up could occur automatically on the device or be approved by the user at the time of the transaction. The user's rounded up amounts are tallied over time until the user decides to distribute them to a third party, for example, a non-profit organization or fundraising campaign.

With an on-screen menu, as illustrated in FIG. 3, the user may choose to augment the rounded-up amount with the push of a button, increasing the rounded-up amount from $0.28 to $5.28 or $100.28, for example.

The funds may be credited to a central receiving party. The receiving party in turn allows the user to donate the accumulated amount to a third party, like a non-profit organization or fundraising campaign. The central receiving party then distributes those funds to the third party or parties elected by the user, for example, non-profit organizations or fundraising campaigns.

In one example, the user may round-up a purchase amount on March 1^{st}, but not donate the funds until September 1^{st}. In this example, the funds may generate interest over the time they are held by the central receiving party. The central receiving party may be entitled to keep the interest generated from the funds it holds during that time, or the interest may be added to the donated amount.

In another example, the elected rounded up amount may be included in the user's purchase at a retail shop. In this example, the retailer would be responsible for the disbursement of funds to a third party.

In another example, the rounded up amount may go toward the purchase of virtual goods. In other words, the central receiving party sells virtual goods to the user. In the previous example of the 28 cent rounded up amount, the user actually purchases 28 widgets. The user can later send the widgets to a third party, like a non-profit organization or fundraising campaign, at which point the central receiving party converts the widgets back to currency and gives real currency to the third party.

The present invention involves technology that is capable of communicating with multiple parties, including but not limited to, a mobile phone or smart phone, retailer, mobile wallet, and website, and possibly financial institutions.

### Potential Roles of a Retailer

There are various ways a retailer can enhance a user's rounded up amount on a purchase, for example, by matching the rounded up amount with an in-store discount. If a user rounds up by 28 cents, the retailer may make that donation on behalf of the user. Alternatively, the retailer may add the same amount to the rounded up amount [making it 28 cents (user)+28 cents (retailer)=56 cents total] to enhance the user's rounded up amount. In that regard, the retailer matches the user's rounded up amount and also reinforces the user's allegiance to the retailer because the retailer is honoring whatever third party, like a non-profit organization or fundraising campaign, is important to the user.

The retailer may also double, triple, and so on, the user's rounded up amount.

Further, a retailer may deposit an amount, for example, $20, into a user's rounded up amount account as a promotion. The user is then free to advance those monies to a non-profit organization or fundraising campaign. However, the user only “earns” the $20 if they shop at the retailer's store in a set amount of time (for example, they must buy $200 at the retailer's store within 30 days for the $20 to be credited in real money to the user's third party of choice).

The disclosed application can allow for numerous variations of ways to calculate the relationship between specific variables, including (among other options) the rounded up amount, a potential discount, matching funds, future discounts, and contributions to particular non-profit organizations or fundraising campaigns.

In some embodiments, a retailer may have a non-profit organization or fundraising campaign that it supports (for example, the Red Cross), and a user can elect to donate their rounded up amount to the retailer's campaign, and/or split the rounded up amount between the retailer's campaign and the user's campaign.

### Extras

An ecosystem can be created that connects the funds from rounded up amounts to third party fundraising campaigns on websites like Kickstarter, GlobalGiving and Kiva, among others. Thus, a central website may offer all campaigns in a single destination and allow users to go there to distribute their accumulated rounded up funds.

Also, retailers may begin to show a physical symbol or sticker that announces the ability for a user to utilize the present invention at that retailer's place of business and therefore partner with that retailer (in a way) to do good in the world.

In another embodiment, the user could designate specific merchants in advance and receive location-specific messages (via GPS, Wi-Fi, or other location technologies), offers or benefits when in proximity to a retailer participating in the program. The user could also designate certain non-profits or charitable institutions whose location may trigger similar notices or messages. Thus, the user on foot could be alerted to the existence of a retailer or non-profit and engage in a purchase, yielding additional savings, or make a donation.

A user may assign a name or number to the user's personal fundraising cause. That number is associated with that user's efforts to raise money. The user can utilize that number to recruit friends to a particular fundraising campaign. This could also cause location-specific notices to be sent to friends when they are in physical proximity to a participating retailer or designated non-profit.

The rounded up amount may be incorporated into an online retail store and catalogue in some embodiments, where users can round up their purchases, but also share with others their own “store” on social networking sites that promote products they like.

In some embodiments, the disclosed invention tracks the spending habits of an individual instead of, or in addition to, operating as a payment system. The system can read the individual's payment or donation history and can offer analyses of the data, such as amount spent over the previous week, month, year, etc.

### Integration with Social Media/Social Networking Sites

In some embodiments, the present invention can be integrated with social media and social networking sites. The system can be a social media platform that uses an algorithm to measure, accumulate, and direct users' transactional round-ups on purchases into fundraising campaigns. The algorithm can measure the cumulative amount of transactional round-ups committed to a specific campaign and can also score the amount of attention a campaign is receiving by assigning numerical values to social media postings such as, but not limited to, “Likes” and “Shares” on Facebook, “Tweets” on Twitter, “Hashtags” on Facebook and Twitter, and other mechanisms that illustrate audience enthusiasm for a particular campaign.

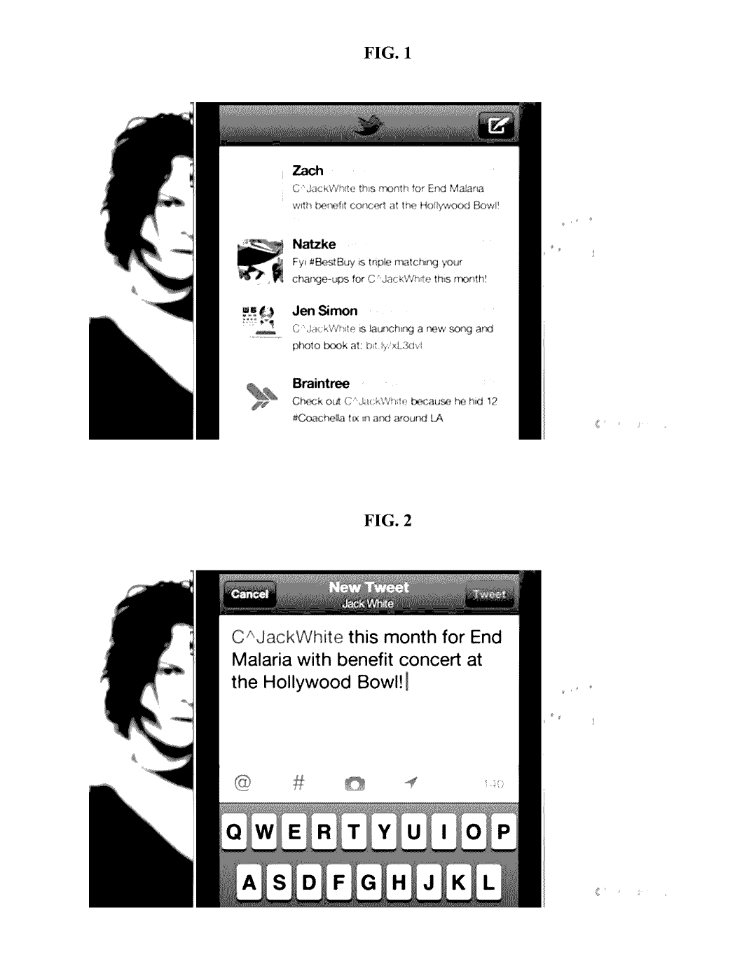

For example, a user may want to lead a fundraising effort on a social network, such as Twitter or Facebook. The user might post an update to their social networking profile that includes a previously designated combination of characters (for example, “Ĉ”) that, when included before a series of words, create a hyperlink to a specific non-profit organization or fundraising campaign. Examples of integration of the present invention with social media are shown in FIG. 1 and FIG. 2.

In some embodiments, the system may incorporate its own social media site that contains a social news feed. On the site, a user can donate funds. For example, there may be a button that states “2 cents” that enables a user to donate a predetermined amount of money. In some cases, a user can increase the predetermined amount of money by, for example, “supersizing” the donation. A social media site enables users to see which of their contacts are donating to the same or similar campaigns or causes and/or how much their contacts have donated.

The integration of the present invention with social networking sites allows users to lead, promote and contribute to fundraising campaigns using a previously designated character or combination of characters that is/are inter-operable with a mobile application or any other application that relates to the present invention, like a digital wallet application, and allows users to automatically apply their rounded up amounts to a non-profit organization or fundraising campaign of their choosing. The rounded up amounts may be applied on a one-time basis in some examples, or may be applied for a specified period of time (i.e., one month).

As an example of the integration with social media, a user might want to use the social networking site Twitter as a means to promote or contribute to a fundraising campaign led by a celebrity, like Jack White. In this example, the user would “tweet” the following: “#ĈJackWhite” followed by any phrase that they think might entice others to promote or contribute to the designated non-profit organization or fundraising campaign. For example, a user might tweet the following: “#ĈJackWhite this month for End Malaria with benefit concert at Hollywood Bowl!” (See FIG. 2) In that tweet, the portion “#ĈJackWhite” becomes a hyperlink when posted to Twitter, allowing other users to click on the hyperlink and automatically enroll in the fundraising campaign and apply their rounded up amounts toward the campaign. In some examples, clicking this hyperlink may automatically enroll the user for a certain amount of time, i.e., one month. Other users may also have the ability to “re-tweet” the aforementioned phrase in order to further promote the designated non-profit organization or fundraising campaign. The notation “Ĉ” used in this example may be any notation that is previously designated by the social networking site for this purpose, and is used here only as an example of what the notation may be.

In some embodiments, the disclosed application may send a notification to the donor or to the recipient of funds (for example, a non-profit organization or fundraising campaign) when funds are donated using the system. These notifications may be sent to a user or fund recipient through a social network, such as Twitter or Facebook, or may be sent by other delivery routes such as email or text message.

Updates to a user's social networking profile related to the present invention can be done in any way that is allowed by the social networking site, for example by use of a personal computer, smart phone or other mobile device. The illustrations in FIG. 1 and FIG. 2 show an example of a combination of characters that create a hyperlink within a user's Twitter update, which has been integrated into a social media mobile application.

The present invention can also be used in social media to facilitate gamification of fundraising campaigns. More specifically, the invention not only provides technology that allows users to round-up their purchases, but also bundles those round-ups into a larger marketplace that assigns values and directs those values to a specific campaign.

For example, a user can choose a specific organization or a general category, such as climate change, for a fundraising effort to which they want to donate. If the user chooses to donate to a general category, the specific organization that will receive the donation can be dependent upon the organization's social media presence, with the organization that receives the most social media attention being the organization that also receives the most, or all, of the general category donations.

One example of determining an organization's social media presence is by calculating total points, or a social media score, by using a formula. For example, for one organization, the formula may multiply the total number of specific donations, or the total value of the donations, to that organization by the sum of “Likes,” “Shares,” “Hashtags,” and “Retweets,” that the organization receives in general or in response to the donation. In another example, certain types of social media attention may receive a greater weight in the formula. For example, “Shares” may be multiplied by 5 because they indicate a stronger social connection to a user than a “Like.” Further, “Hashtags” may be multiplied by 3 and “Retweets” may be multiplied by 5. Another example of a formula removes the element of specific donations and only counts social media presence. The scores can be accumulated over the competition's time period, which can be daily, weekly, monthly, quarterly, annually, etc.

In one embodiment, users can elect, at the time of the donation, whether or not their donations are subject to the various competitions. Alternatively, users can opt out of the competition and simply assign their donations to a single cause of their choice.

In another embodiment of the competition, users may be able to create a one v. one competition, wherein each user supports a specific organization and the users attempt to increase their representative organization's scores by having other users donate to one of the two organizations in the competition. One example of where this type of competition could be especially effective is when public figures, such as celebrities, engage in a public competition to bring awareness to causes and to foster friendly competition among fans. In one embodiment, at the end of the competition, the organization that has the highest score can win the other organization's accumulated donations.

In a further embodiment, concerts, sporting events, and retail outlets can compete against each other to send all of their round-ups to pre-chosen causes. For example, all National Football League (NFL) stadiums in a given day can compete against each other to see which stadium's fan base can bring the most attention to a local cause on social media. The stadium that ends the competition with the greatest number of points (for example, by using a formula similar to the one described above) can win all of the round-up donations for that week.

### Leaderboards

In one embodiment, leaderboards can be created for individual users. For example, each user can be rated according to the total number or total value of round-up donations the user generates and the amount of social media interactions the user receives. The individual leaderboard can be determined using a formula similar to the variations described above. Users can then compete against each other to generate the greatest number or value of round-up donations for a particular cause, such as, but not limited to, an alma mater, non-governmental organization, political campaign, hospital campaign, etc. In one embodiment, as motivation, the top ten leaders on each leaderboard for each category of cause can get special treatment from that cause.

In some embodiments, user's can track their donations and voluntarily donate to their campaign even if they are not making a purchase. This may enable a user to be placed on a leaderboard or be placed further up on the leaderboard for a specific month. By enabling competitive donations, the system may encourage individuals to share leaderboard news on social media and/or challenge others. In some embodiments, if a user is a leader over a predetermined amount of time (ex: twelve months), the user can be rewarded.

In one embodiment, users who have amassed a pre-defined threshold of round-up donations or who have become top users through the leaderboard can operate as bundlers. Bundlers can be trusted leaders in the donation community who are eligible to receive the round-up donations from other users who trust the bundler to disperse the funds wisely. Further, a bundler can receive a small commission for each user the bundler invites to use the system, thus building the bundler's value with every user recruited.

In some embodiments, bundlers could operate as a form of electoral college, wherein all of the bundlers' constituents move round-up donations through them. This infuses the ecosystem with politics, competition, and lobbying that allows for dynamic interactions. If a user does not want to be involved in this type of system, however, the user can opt out of the leaderboard feature and simply engage as a standalone experience where the user has a direct relationship with the cause the user is benefitting. This would be appropriate if a user was donating to, for example, a grandchild's college fund.

### Mutual Funds

Millions of people may round up amounts on purchases daily, therefore contributing large amounts of monies into a central holding fund, which may operate as a bank of sorts, or a mutual fund that grows, earns interest, and delivers dividends. Therefore, a user can “donate” to his or her own account in order to save or invest money.

### System Technical Components

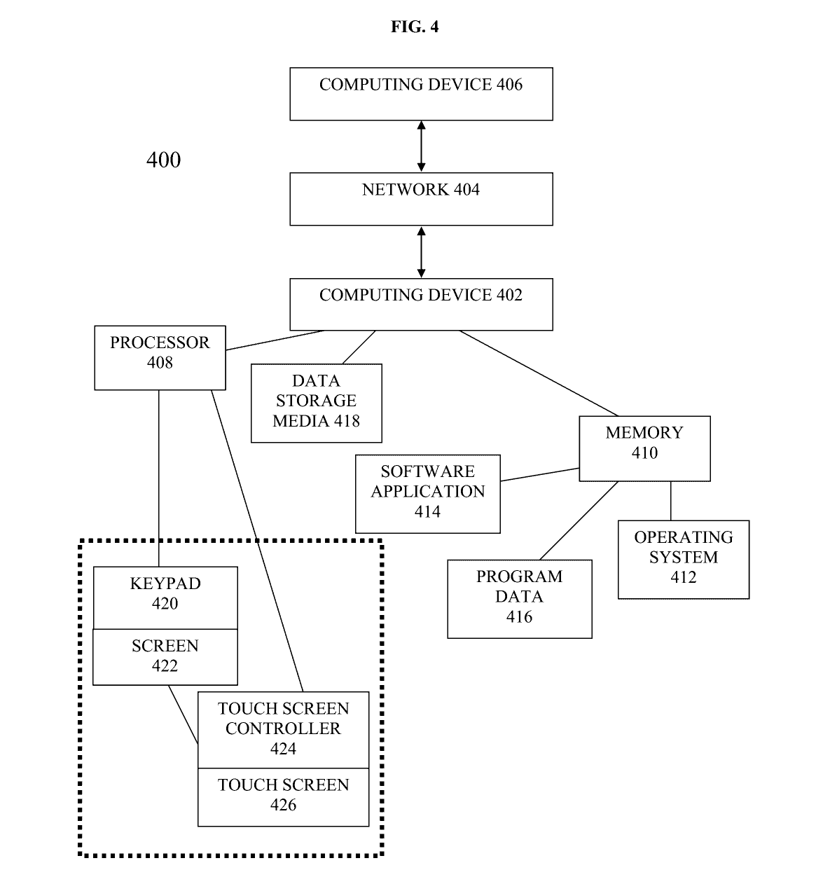

In general terms, the present disclosure relates to an online or mobile application that is executed using a computing system. FIG. 4 is a schematic block diagram of an example computing system 400. The disclosed application involves technology that communicates with a mobile phone, retailer, mobile wallet, and website, and possibly financial institutions, and more, and uses a computing system 400. The example computing system 400 includes at least one computing device 402. In some embodiments the computing system 400 further includes a communication network 404 (such as the internet or a cellular network) and one or more additional computing devices 406 (such as a server to host a payment system).

The computing device 402 can be, for example, a smart phone or other mobile device, a tablet computing device, a netbook, a computing device located in a retail store or other place of business, a computing device located in a user's home, or any other computing device. Computing device 402 can be a stand-alone computing device or a networked computing device that communicates with one or more other computing devices 406 across a network 404. The additional computing device(s) can be, for example, located remotely from the first computing device, but configured for data communication with the first computing device across a network 404.

In some examples, the computing device 402 and 406 includes at least one processor or processing unit 408 and system memory 410. Depending on the exact configuration and type of computing device, the system memory 410 may be volatile (such as RAM), non-volatile (such as ROM, flash memory, etc.) or some combination of the two. System memory 410 typically includes an operating system 412 suitable for controlling the operation of the computing device, such as the WINDOWS® operating systems from Microsoft Corporation of Redmond, Wash. or a server, such as Windows SharePoint Server, also from Microsoft Corporation. To provide further example, if the computing device 402 is a smart phone or other mobile device, the operating system 412 may be iOS, WP7, Android, or any other available mobile operating system. The system memory 410 may also include one or more software applications 414 and may include program data 416. The software applications 414 may be in the form of mobile applications in examples wherein the computing device 402 is a mobile device.

The computing device 402 may have additional features or functionality. For example, the device may also include additional data storage devices 418 (removable and/or non-removable) such as, for example, magnetic disks, optical disks, or tape. Computer storage media 418 may include volatile and nonvolatile, removable and non-removable media implemented in any method or technology for storage of information, such as computer readable instructions, data structures, program modules, or other data. System memory, removable storage, and non-removable storage are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by the computing device. An example of computer storage media 418 is non-transitory media. The computing device 406 may include data storage media such as the data storage media 418 described above, on which application data is stored.

In some examples, one or more of the computing devices 402, 406 can be located in an establishment, such as a retail store or other place of business. In other examples, one or more of the computing devices 402, 406 can be a smart phone or other mobile device. FIG. 4 includes a schematic diagram of such device. The computing device 402 may be a smart phone or other mobile device with input device options including, but not limited to, a keypad 420, a screen 422, a touch screen controller 424, and/or a touch screen 426. In other examples, the computing device can be a personal computing device that is networked to allow the user to access the application disclosed herein at a remote location, such as in a user's home or other location. In some embodiments, components of the application are stored as data instructions for a smart phone application. A network 404 facilitates communication between the computing device 402 and one or more servers, such as an additional computing device 406, that host the application. The network 404 may be a wide variety of different types of electronic communication networks. For example, the network may be a wide-area network, such as the Internet, a local-area network, a metropolitan-area network, a cellular network or another type of electronic communication network. The network 404 may include wired and/or wireless data links. A variety of communications protocols may be used in the network including, but not limited to, Ethernet, Transport Control Protocol (TCP), Internet Protocol (IP), Hypertext Transfer Protocol (HTTP), SOAP, remote procedure call protocols, and/or other types of communications protocols.

In some examples, the additional computing device 406 is a Web server. In this example, the first computing device 402 includes a Web browser that communicates with the Web server to request and retrieve data. The data is then displayed to the user, such as by using a Web browser software application. In some embodiments, the various operations, methods, and rules disclosed herein are implemented by instructions stored in memory. When the instructions are executed by the processor of one or more of the computing devices 402 and/or 406, the instructions cause the processor to perform one or more of the operations or methods disclosed herein. Examples of operations include the rounding up of a purchase to the nearest dollar, the storage of the funds originating from the rounded up amount and/or the delivery of location-specific messages, offers or benefits.

As noted, the application could work in combination with existing digital wallet applications or be its own digital wallet application with the round-up functionality and social network engagement embedded therein.

The various embodiments described above are provided by way of illustration only and should not be construed to limit the claims attached hereto. Those skilled in the art will readily recognize various modifications and changes that may be made without following the example embodiments and applications illustrated and described herein and without departing from the true spirit and scope of the following claims.

What is claimed is:

1. A method of facilitating donations using a computing system comprised of at least one server to host a payment system and at least one computing device communicably coupled to the at least one server through a communication network, the method comprising:
a retailer charging a customer a price in exchange for a good;
the customer offering to make an electronic payment through the at least one computing device;
the at least one computing device presenting an additional payment option to the customer;
the customer selecting the additional payment option and selecting a third party that will receive the additional payment option;
the customer selecting an amount for the optional additional payment;
the customer making the electronic payment for the price of the good and the additional payment option.

2. The method of claim 1, wherein the at least one computing device is a mobile device communicably coupled with the at least one server.

3. The method of claim 1, wherein the additional payment option is a pre-determined amount.

4. The method of claim 1, wherein the third party is chosen from a plurality of third parties.

5. The method of claim 4, further comprising a second computing device calculating a social media score for each third party.

6. The method of claim 5, wherein each social media score is calculated by adding together a number of positive responses posted on a social media platform.

7. The method of claim 6, wherein at least some of the positive response are weighted.

8. The method of claim 5, wherein the second computing device compares the social media scores between each third party, selects the third party with the highest score, and presents the third party to the customer for selection.

9. A system for electronic, charitable donations comprising:
a computer network for management and transmission of online payment data for an individual and designation of charitable organizations to receive payment;
a data storage device for storing individual online payment data, designation of a charitable organization to receive payment, and the geographic location of the charitable organization;
a first server configured to receive data regarding geographic location of the individual;
a mobile computing device configured to transmit the geographic location data of the individual; and
a second server configured to transmit information on the charitable organization associated with the geographic location data of the individual.

10. The system of claim 9, further comprising a computing device configured to make a payment to the charitable organization associated with the geographic location data of the individual.

11. The system of claim 10, wherein the computing device is configured to enable the individual to transmit the online payment data to a social media feed.

12. A computing system used to facilitate competition between fundraising campaigns for a pool of donations, the system comprising:
a digital wallet having input device options, a processing device, and a memory device; and
at least one computing device;
wherein the digital wallet is communicably coupled to the at least one computing device through a communication network, and the memory device stores instructions that, when executed by the processing device, cause the processing device to:
receive a round-up donation from a plurality of users, wherein the round-up donation is a second payment based on a first payment for a purchase the user makes;
receive instructions from the user to donate the round-up donation to a general category of fundraising to create a pool of donations, wherein the general category of fundraising contains a plurality of fundraising campaigns participating in a pending competition that lasts for a pre-determined length of time; and
wherein the at least one computing device has a processing device and a memory device that stores instructions that, when executed by the computing device's processing device, cause the computing device's processing device to:
calculate a first social media score for a first fundraising campaign, wherein the first social media score is based on the amount and type of social media posts that mention the first fundraising campaign;
calculate a second social media score for a second fundraising campaign, wherein the second social media score is based on the amount and type of social media posts that mention the second fundraising campaign;
determine whether the first or the second fundraising campaign won the competition by comparing, at the end of the pre-determined length of time, the first social media score to the second social media score, wherein the fundraising campaign with the higher media score at the end of the pre-determined length of time is the winner of the competition; and
send the pool of donations to the winner of the competition.
